(19) United States
(12) Patent Application Publication
(10) Pub. No.: US 2020/0367136 A1
(43) Pub. Date: Nov. 19, 2020

(54) CONTROL DEVICE, COMMUNICATION SYSTEM, AND CONTROL METHOD

(71) Applicant: NEC Corporation, Minato-ku, Tokyo (JP)

(72) Inventor: Koji KAWADA, Tokyo (JP)

(73) Assignee: NEC Corporation, Minato-ku, Tokyo (JP)

(21) Appl. No.: 16/772,973

(22) PCT Filed: Dec. 19, 2018
(86) PCT No.: PCT/JP2018/046858

§ 371 Date: Jun. 15, 2020

(30) Foreign Application Priority Data
Dec. 27, 2017 (JP) 2017-251493

(51) Int. Cl. H04W 40/14; H04W 72/04; H04W 72/10

(52) U.S. Cl. CPC H04W 40/14; H04W 72/10; H04W 72/048

(57) ABSTRACT

The purpose of the present invention is to provide a control device, a communication system, and a control method which make it possible to perform route allocation in consideration of not only the current communication situation but also the frequency and tendency of the occurrence of communication failure, and in accordance with path priority. A control device 10 is a control device which controls communication devices 2A, 2B, and 2C including a wireless communication section and configuring a communication net. The control device comprises: a storage unit 11 in which a communication failure history in the wireless communication section is stored; a determination unit 12 which, on the basis of the communication failure history, determines the stability of the wireless communication section; and a route allocation unit 13 which allocates a communication route on the basis of the stability.

### TECHNICAL FIELD

The present technique relates to a control device, a communication system, and a control method, and relates to a control device, a communication system, and a control method for controlling allocation of a communication route in a network including a wireless communication section.

### BACKGROUND ART

In a backbone network such as a mobile backhaul network, a fixed wireless access is used. The fixed wireless access has a problem that, whereas there is an advantage such as a low introduction cost, communication quality may be degraded due to occurrence of a communication failure such as fading. Patent Literature 1 (PTL1) and Patent Literature 2 (PTL2) disclose a technique for controlling a communication route in association with this.

A network monitoring control device disclosed in PTL1 calculates a bypass communication route in descending order of a relative priority among lines, based on a service level regulation, in an emergency, including an upper limit of a service interruption time, and line quality, when a major fault such as a catastrophic disaster occurs. Thus, the network monitoring control device enables setting a communication route, and a schedule including an order and a deadline.

PTL2 describes a technique of setting, as a target base station, a neighbor base station in which a radio wave receiving level is on the upward trend and stable, and switching a base station, when a receiving level of a radio wave received from a serving base station is on the downward trend, and a calculated value of a serving approximate expression is smaller than a calculated value of a neighbor base station approximate expression.

### CITATION LIST

### Patent Literature

[PTL1] Japanese Patent Application Laid-open No. 2015-041976

[PTL2] Japanese Patent Application Laid-open No. 2012-028831

### SUMMARY OF INVENTION

### Technical Problem

However, the configuration of PTL1 is a technique of setting a communication route and the like at a time of occurrence of a major fault such as a catastrophic disaster. In the configuration of PTL1, even when a virtual line having a high priority is set in a communication network including a wireless communication section, communication quality degradation similar to another line may occur.

In the present description, a virtual line which is set between two communication devices in a communication network, and to which a communication route for connecting these devices is allocated, is referred to as a virtual line. In the virtual line, a priority is set, and a communication route is allocated based on the priority.

The configuration of PTL2 is merely a configuration considering stability of a receiving level of a neighbor base station in a technique for switching from a target base station to a serving base station. Also in the configuration of PTL2, even when a virtual line having a high priority is set in a communication network including a wireless communication section, communication quality degradation may occur similarly to another line.

A main object of the present invention is to provide a control device, a communication system and a communication route control method which enable allocating a communication route according to a priority of a virtual line, when a virtual line is set between two communication devices in a communication network including a wireless communication section.

### Solution to Problem

A control device according to one aspect of the present invention is a control device for controlling a communication device constituting a communication network including a wireless communication section, and includes: a storage unit that stores a communication failure history in the wireless communication section; a determination unit that determines stability of the wireless communication section, based on the communication failure history; and a route allocation unit that allocates a communication route, based on the stability.

A communication system according to another aspect of the present invention includes the above-described control device, and a plurality of communication devices that perform communication on the communication route.

A control method according to yet another aspect of the present invention is a control method of a control device for controlling a communication device constituting a communication network including a wireless communication section, and includes: storing a communication failure history in the wireless communication section; determining stability of the wireless communication section, based on the communication failure history; and allocating a communication route, based on the stability.

### Advantageous Effects of Invention

The above-described aspects of the present invention enable allocating a communication route according to a priority of a virtual line, when a virtual line is set between two communication devices in a communication network including a wireless communication section.

### BRIEF DESCRIPTION OF DRAWINGS

FIG. 1 is a block diagram illustrating one example of a configuration according to a first example embodiment.

FIG. 2 is a block diagram illustrating one example of a configuration of a control device in FIG. 1.

FIG. 3 is a diagram illustrating one example of a communication failure history according to the first example embodiment.

FIG. 4 is a diagram illustrating one example of an operation of a route allocation unit according to the first example embodiment.

FIG. 5 is a diagram illustrating another example of an operation of the route allocation unit according to the first example embodiment.

FIG. 6 is a flowchart illustrating one example of a route allocation operation according to the first example embodiment.

FIG. 7 is a block diagram illustrating one example of a configuration according to a second example embodiment.

FIG. 8 is a flowchart illustrating one example of a route allocation operation according to the second example embodiment.

### EXAMPLE EMBODIMENT

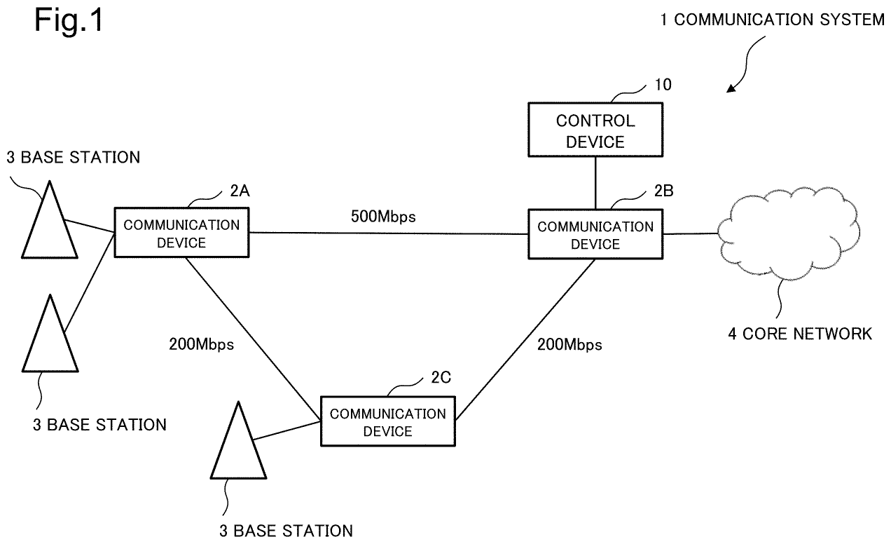

Next, an exemplary first example embodiment is described with reference to the drawings. FIG. 1 is a block diagram illustrating one example of a configuration according to the first example embodiment. As illustrated in FIG. 1, a communication system 1 according to the first example embodiment includes communication devices 2A, 2B, and 2C being a plurality of wireless communication devices; and a control device 10 communicable with the communication device 2B being one of the plurality of the communication devices, and configured to control the plurality of communication devices 2A, 2B, and 2C. A base station 3 is connected to the communication devices 2A and 2C being at least a part of the plurality of the communication devices, and a core network 4 is connected to the communication device 2B being one of the plurality of the communication devices. A communication network of the communication system 1 is constituted of these. The communication network includes a wireless communication section among the communication devices 2A, 2B, and 2C, for example. The control device 10 is not limited to a configuration in which the control device 10 is connected to the communication device 2B to which the core network 4 is connected. Any configuration in which the control device 10 is connected to the communication network may be adopted, as long as the control device 10 is communicable with the communication devices 2A, 2B, and 2C in the communication network.

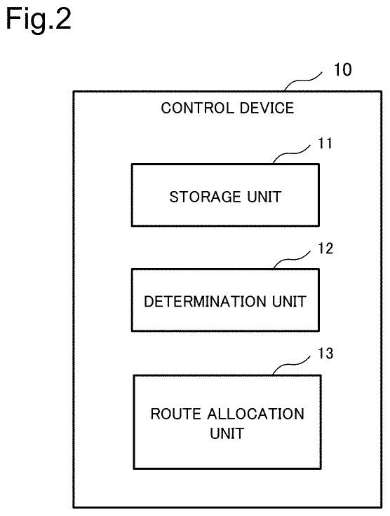

FIG. 2 is a block diagram illustrating one example of a configuration of the control device in FIG. 1. As illustrated in FIG. 2, the control device 10 includes a storage unit 11, a determination unit 12, and a route allocation unit 13. The storage unit 11 stores a communication failure history in a wireless communication section. For example, information on a communication failure occurring in a predetermined past period, for example, in a past one week may be recorded in the communication failure history in association with a communication route present between two communication devices regarding a pair of communication devices in a wireless communication section. The communication route to be listed may be, for example, a communication route for connecting two communication devices without another communication device in between; and a communication route for connecting two communication devices via one or more communication devices, and being a communication route on which the number of communication devices in between is equal to or smaller than a predetermined value. As the information on a communication failure to be stored in the communication failure history, various pieces of information may be proposed. For example, a time during which a communication failure has occurred may be recorded in seconds.

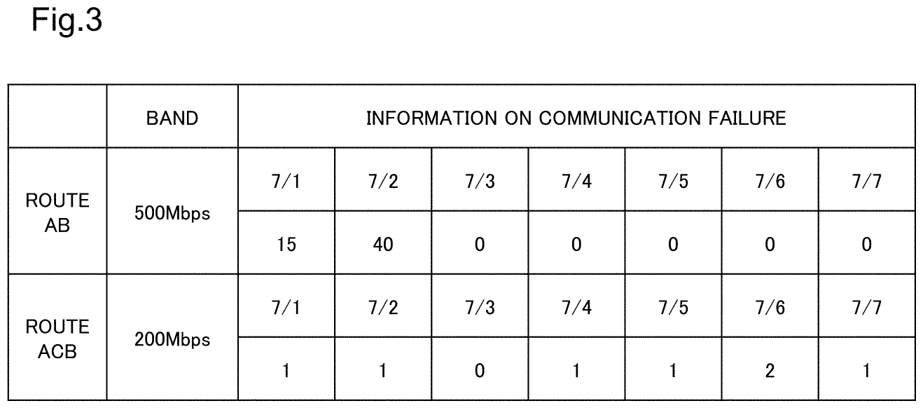

FIG. 3 is a diagram illustrating one example of a communication failure history according to the present example embodiment. As illustrated in FIG. 3, the storage unit 11 records, in a communication failure history, information on a communication failure in association with two communication routes with respect to a pair of the communication device 2A and the communication device 2B, for example. One communication route AB is, for example, a communication route from the communication device 2A to the communication device 2B without another communication device in between. The other communication route ACB is, for example, a communication route from the communication device 2A to the communication device 2B via the communication device 2C. For example, 15 indicates an example that a time during which a communication failure has occurred is recorded in seconds. The communication failure history records that, regarding the communication route AB, a time during which a communication failure has occurred is fifteen seconds on July 1st, forty seconds on July 2nd, and zero second from July 3rd to July 7th; and regarding the communication route ACB, a time during which a communication failure has occurred is one second on July 1st and July 2nd, zero second on July 3rd, one second on July 4th and July 5th, two seconds on July 6th, and one second on July 7th.

A band of a communication route is recorded in the communication failure history in association with each of the communication routes. As illustrated in FIG. 3, bands such as 500 Mbps and 200 Mbps, for example, are recorded in association with the communication route AB and the communication route ACB.

The communication failure history is, at normal time, generated from each of the communication devices by the determination unit 12, for example, based on information to be periodically collected by the control device 10, and is stored in the storage unit 11.

The determination unit 12 calculates and determines stability of each of the communication routes between two communication devices for which a virtual line is newly set. Specifically, when communication devices at a start point and an end point of a virtual line to which a communication route is newly allocated, and a band of the virtual line are acquired, first, the determination unit 12 refers to a communication failure history stored in the storage unit 11, and specifies, among communication routes selectable between the communication device at the start point and the communication device at the end point for which a virtual line is newly set, a communication route within which the band of the virtual line to be allocated lies. Then, the determination unit 12 calculates and determines stability regarding the specified communication route, each based on communication failure information stored in the communication failure history.

Various patterns are proposed as a stability calculation method. As a first pattern, the determination unit 12 may calculate stability as a numerical value, based on a total time of occurrence of a communication failure occurring in a past one week, for example, specifically, a failure occurrence total time. In this case, the determination unit 12 determines that stability is high, when an occurrence time is shorter. When calculation is performed by this pattern, in the example of FIG. 2 above, stability of the communication route AB becomes 55, stability of the communication route ACB becomes 7, and it is determined that stability of the communication route ACB is high compared with the communication route AB.

As a second pattern, for example, the determination unit 12 may calculate stability, based on an occurrence frequency of a communication failure occurring in a past one week, for example. In this case, the determination unit 12 determines that stability is high, when the number of days of occurrence is smaller. When calculation is performed by this pattern, in the example of FIG. 3, stability of the communication route AB becomes 2, and stability of the communication route ACB becomes 6, therefore, it is determined that stability of the communication route AB is high compared with the communication route ACB.

As a third pattern, for example, the determination unit 12 may predict a period when a communication failure is likely to occur from a time zone in which a communication failure has occurred in a past one week, for example, and calculate stability. In this case, the determination unit 12 determines, from a distribution of occurrence time zones, that stability is low in a time zone in which a communication failure frequently occurs, and determines that stability is high in a time zone in which a communication failure less frequently occurs. In the example of FIG. 3, it is determined that, regarding the communication route AB, stability is low at the beginning of the week, and thereafter, stability is high. Regarding the communication route ACB, it is determined that stability is high regardless of a period.

Not only in the example of FIG. 3, in an environment in which it is foggy in the morning, for example, a communication failure time is generally long in the morning. The determination unit 12 may determine a time zone in which stability is low in a day. In an environment in which radio wave interference rarely occurs and a communication failure does not occur on a weekend, but a communication failure frequently occurs in a specific time zone of the other days of the week, the determination unit 12 may determine a day of the week or a time zone in which stability is low within a week.

The route allocation unit 13 acquires a priority of a virtual line to which a communication route is newly allocated, acquires, from the determination unit 12, a priority of another existing virtual line and stability of a communication route thereof, and determines whether a communication route having stability according to the priority of the new virtual line is allocated to the another existing virtual line, based on a result of comparison between the priority of the new virtual line and the priority of the another existing virtual line. When allocation is not performed, the route allocation unit 13 allocates, to the new virtual line, a communication route having stability according to the priority. When allocation is performed, the route allocation unit 13 changes the communication route of the another virtual line, and allocates, to the new virtual line, a communication route having stability according to a priority. The route allocation unit 13 stores a communication route and a priority of the another virtual line to which a communication route is allocated in the past and is valid even for now.

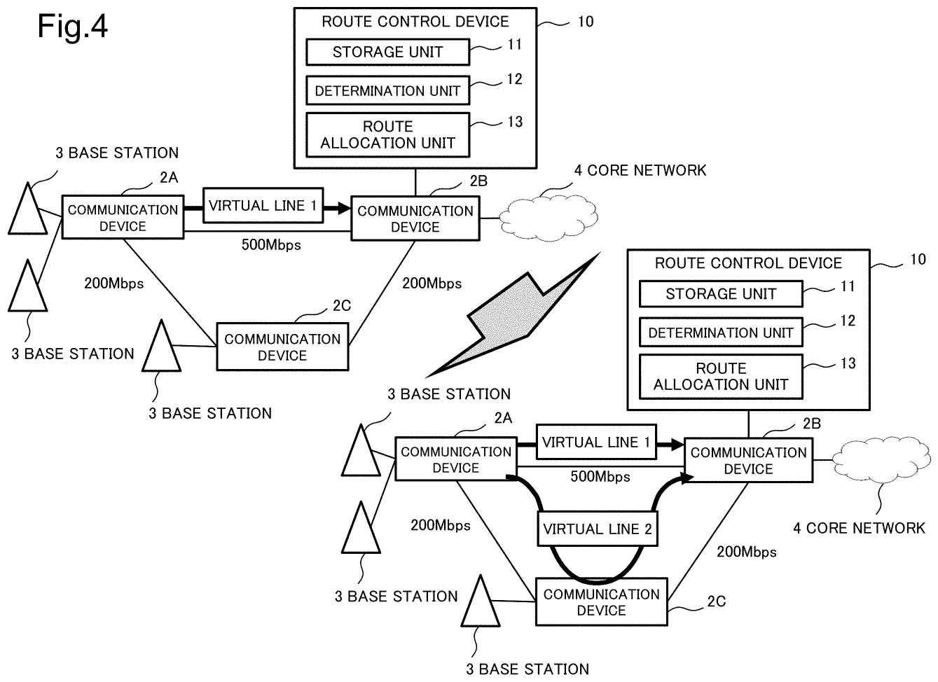

FIG. 4 is a diagram illustrating one example of an operation of the route allocation unit 13 in FIG. 2. The example of FIG. 4 illustrates an example in which a communication route is allocated to a virtual line 2 whose priority is higher than a virtual line 1 in a state that the communication route AB having low stability is allocated to the virtual line 1 of lower priority. Since the communication route ACB whose stability is higher than the communication route AB of the another virtual line 1 is not allocated to another existing virtual line, the route allocation unit 13 determines that changing allocation of a communication route of the virtual line 1 is not necessary, and allocates the communication route ACB to the new virtual line 2.

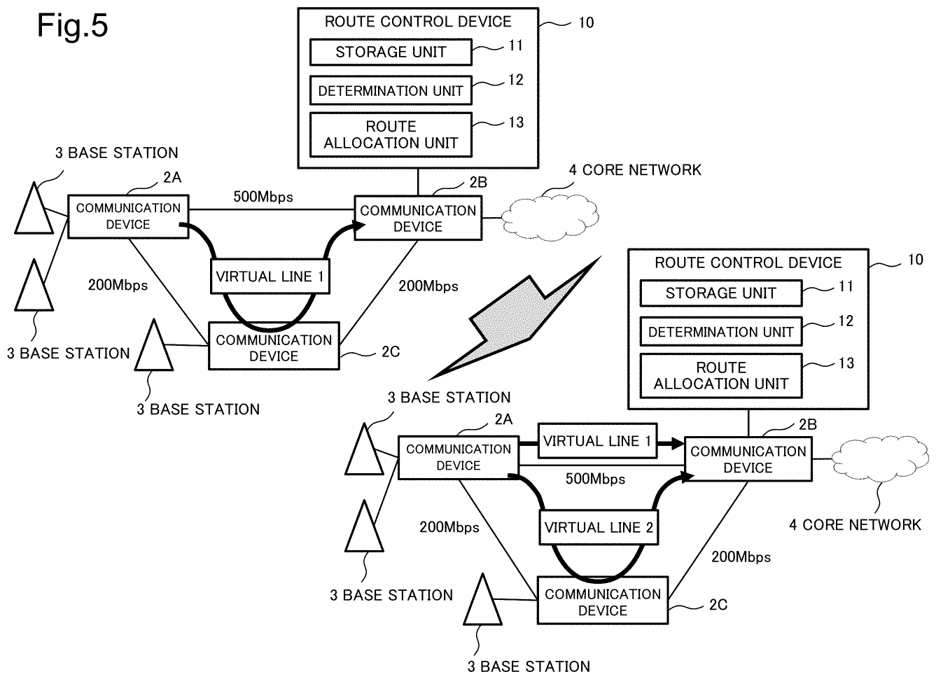

FIG. 5 is a diagram illustrating another example of an operation of the route allocation unit in FIG. 2. FIG. 5 illustrates an example in which a communication route is allocated to the virtual line 2 whose priority is higher than the virtual line 1 in a state that the communication route ACB having high stability is allocated to the virtual line 1 of lower priority. Since there is no communication route whose priority is higher than the communication route ACB of the another virtual line 1, the route allocation unit 13 determines that it is necessary to change route allocation. The route allocation unit 13 changes route allocation of a communication route of the virtual line 1 to the communication route AB whose stability is lower than the currently allocated communication route ACB. Then, the route allocation unit 13 allocates the communication route ACB to the new virtual line 2.

After a communication route having stability according to a priority is allocated to the new virtual line 2, the route allocation unit 13 stores the communication route. The route allocation unit 13 notifies the communication devices 2A, 2B, and 2C of the new virtual line 2 and the communication route thereof. When a communication route of the another virtual line 1 is changed, the route allocation unit 13 notifies the communication devices 2A, 2B, and 2C of the virtual line 1 in which a communication route is changed, and the communication route thereof. The communication devices 2A, 2B, and 2C detect a virtual line of a packet for which communication is performed, and transmits the packet according to the notified communication route.

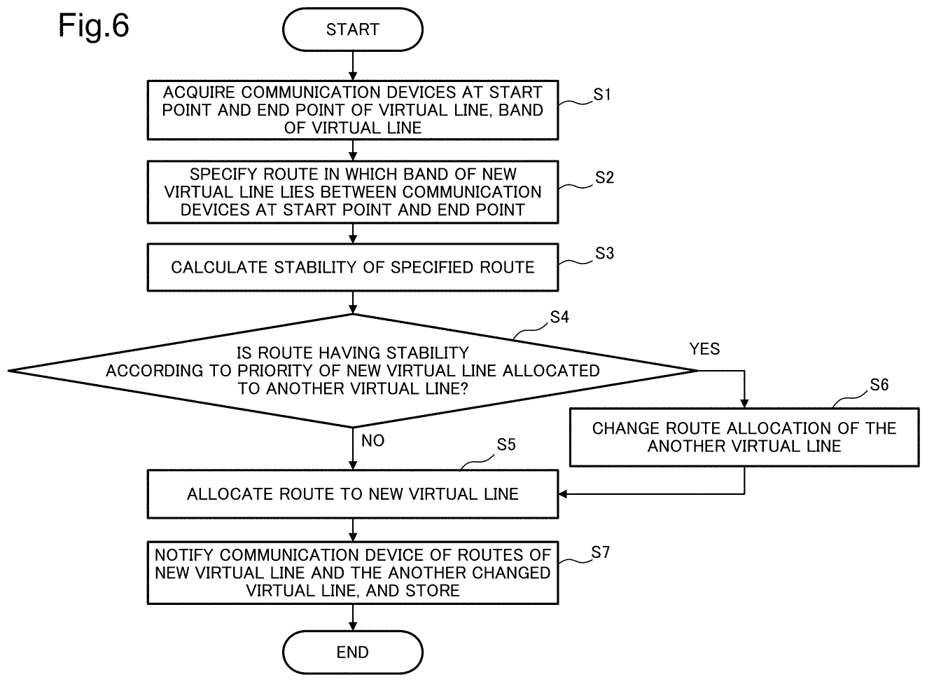

Next, an operation according to the first example embodiment is described. FIG. 6 is a flowchart illustrating an operation according to the first example embodiment.

First, the determination unit 12 acquires communication devices (the communication device 2A and the communication device 2B) at a start point and an end point of the virtual line 2 to which a communication route is newly allocated, and a band (200 Mbps) of the virtual line 2 (Step S1). The determination unit 12 specifies the communication route AB and the communication route ACB as communication routes within which the band 200 Mbps lies on a communication route between the communication device 2A and the communication device 2B by referring to a communication failure history stored in the storage unit 11 (Step S2).

Subsequently, the determination unit 12 calculates and determines stabilities of the specified communication route AB and communication route ACB, based on the communication failure history stored in the storage unit 11. When a stability calculation method is the first pattern, the determination unit 12 calculates stability of the communication route AB as 55, calculates stability of the communication route ACB as 7, and determines stabilities of the communication route AB and the communication route ACB (Step S3).

Subsequently, the route allocation unit 13 determines whether a communication route having stability according to a priority of a new virtual line is allocated to the other virtual lines including the other virtual lines set in the past between two communication devices similar to the new virtual line 2. Specifically, when a priority of a new virtual line is highest, the route allocation unit 13 determines whether a communication route whose stability is higher than a communication route of a virtual line in which a priority is highest among the other virtual lines is allocated to the other virtual lines. When the priority is second highest, the route allocation unit 13 determines whether a communication route whose stability is lower than a communication route of a virtual line in which a priority is highest among the other virtual lines, and whose stability is higher than a communication route of a virtual line in which a priority is second highest among the other virtual lines is allocated to the other virtual lines (Step S4).

When a communication route having stability according to a priority is not allocated to the other virtual lines, the route allocation unit 13 allocates, to a new virtual line, a communication route according to stability. For example, in the example of FIG. 4, since a priority of the new virtual line 2 is higher than the priority of the another virtual line 1 to which a communication route is allocated in the past, and the communication route ACB having higher stability than the communication route AB of the virtual line 1 is not allocated to the other virtual lines, the route allocation unite 13 allocates the communication route ACB to the new virtual line 2 (Step S5).

On the other hand, when a communication route having stability according to a priority is allocated to the other virtual lines, the route allocation unit 13 determines a virtual line for which allocation of a communication route is changeable among communication routes of the other virtual lines, and changes allocation of a communication route of the virtual line. For example, when the priority of a new virtual line is second highest, as long as a communication route whose stability is higher than a communication route of a virtual line in which a priority is highest among the other virtual lines is not allocated to the other virtual lines, the route allocation unit 13 changes the communication route of the virtual line in which a priority is highest among the other virtual lines to a communication route which is not allocated to the other virtual lines.

When a communication route whose stability is higher than a communication route of a virtual line in which a priority is highest among the other virtual lines is allocated to the other virtual lines, the route allocation unit 13 determines whether a communication route whose stability is lower than a communication route of a virtual line in which a priority is second highest among the other virtual lines is allocated to the other virtual lines. When the communication route is not allocated to the other virtual lines, the route allocation unit 13 changes a communication route of a virtual line in which a priority is second highest among the other virtual lines to a communication route which is not allocated to the other virtual lines.

For example, in the example of FIG. 5, the priority of the new virtual line 2 is higher than the virtual line 1 to which a communication route is allocated in the past. However, there is no communication route whose stability is higher than the communication route ACB of the virtual line 1. Since the communication route AB whose stability is lower than the communication route ACB of the another virtual line 1 is not allocated to the other virtual lines, the route allocation unit 13 changes the communication route of the virtual line 1 to the communication route AB which is not allocated to the other virtual lines (Step S6). Then, the route allocation unit 13 allocates, to the new virtual line 2, a communication route having stability according to a priority. For example, in the example of FIG. 5, the route allocation unit 13 allocates, to the new virtual line 2, the communication route ACB having stability according to a priority (Step S5).

After allocating, to the new virtual line 2, a communication route having stability according to a priority, the route allocation unit 13 notifies the communication devices 2A, 2B, and 2C of the new virtual line 2 and the communication route thereof. When the communication route of the another virtual line 1 is changed, the route allocation unit 13 notifies the communication devices 2A, 2B, and 2C of the virtual line 1 in which the communication route is changed, the new virtual line 2, and the communication routes thereof. Further, the route allocation unit 13 stores the communication routes (Step S7). The communication devices 2A, 2B, and 2C store the new virtual line 2, the another virtual line 1, and the communication routes thereof. When communication is performed, the communication devices 2A, 2B, and 2C detect a virtual line of a packet, and transmit the packet along a communication route according to the virtual line of the packet.

As described above, in the present example embodiment, the determination unit 12 calculates and determines stabilities of the communication route AB and the communication route ACB by referring to a communication failure history stored in the storage unit 11, and the route allocation unit 13 allocates, to the new virtual line 2, a communication route having stability according to a priority. Therefore, it is possible to allocate a communication route according to a priority of a virtual line, while not only a current communication situation but also a frequency and a tendency of occurrence of a communication failure are considered.

Next, a second example embodiment is described. The present example embodiment is different from the first example embodiment in a point that monitoring is performed whether there is a communication route deviated from an allocation condition when a communication route is allocated to a virtual line, and in a case where there is a communication route deviated from the allocation condition, allocation of a communication route is changed.

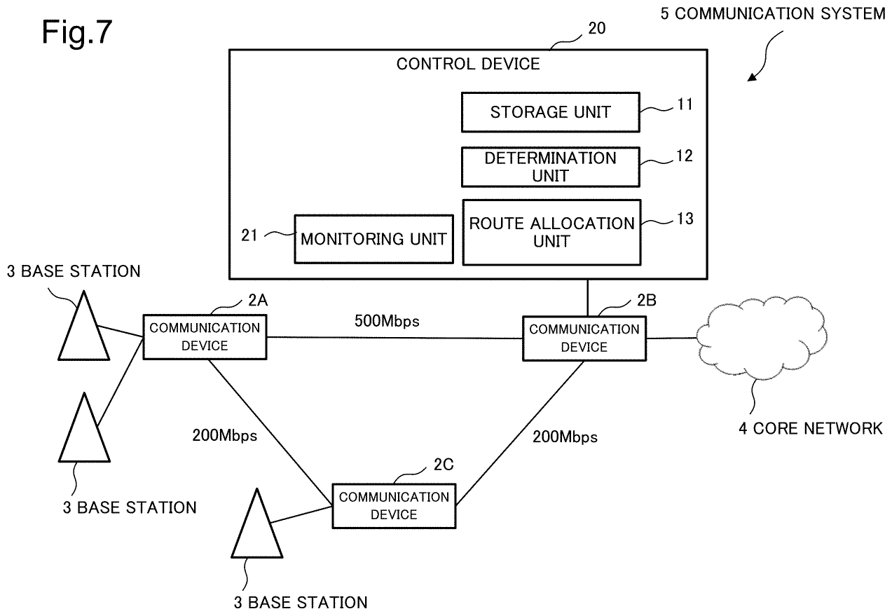

FIG. 7 is a block diagram illustrating a configuration according to the second example embodiment. As illustrated in FIG. 7, a control device 20 of a communication system 5 according to the second example embodiment includes a monitoring unit 21 for monitoring whether there is a communication route deviated from an allocation condition when a communication route is allocated to a virtual line. The monitoring unit 21 acquires, from a communication failure history which is periodically measured and updated in the storage unit 11, a band of each of communication routes, regarding a communication route allocated to a virtual line. The monitoring unit 21 acquires, from the acquired communication failure history, information on a communication failure of each of the communication routes, designates the determination unit 12 to calculate stability of the communication route, and acquires the calculated stability. In a case where the monitoring unit 21 determines that there is a communication route deviated from an allocation condition when a communication route is allocated to a virtual line, based on the acquired band and stability, the monitoring unit 21 designates the route allocation unit 13 to change allocation of a communication route. A state deviated from a condition when a communication route is allocated is, for example, a state in which stability of a communication route of a virtual line having a high priority is lower than stability of a communication route of a virtual line having a low priority, a state in which a band of a communication route is equal to or lower than a band of a virtual line, or the like.

The monitoring unit 21 may designate the route allocation unit 13 to change allocation of a communication route, in a case where a state deviated from an allocation condition when a communication route is allocated to a virtual line is continued for a given period determined in advance.

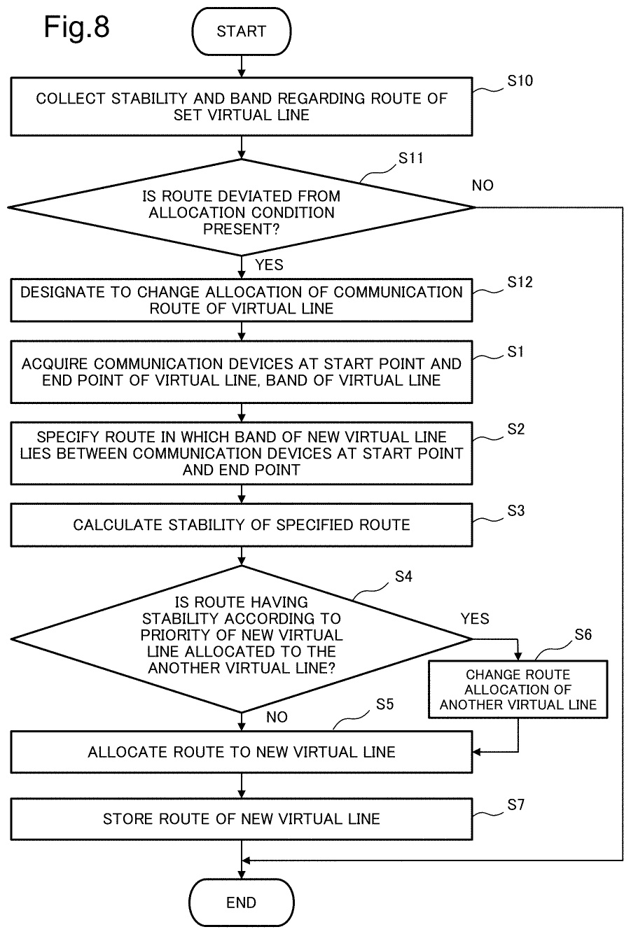

FIG. 8 is a flowchart illustrating an operation according to the second example embodiment. As illustrated in FIG. 8, the monitoring unit 21 acquires a band from the storage unit 11 regarding a communication route allocated to a virtual line. The monitoring unit 21 designates the determination unit 12 to calculate stability of the communication route, and acquires the calculated stability (Step S10). The determination unit 12 determines whether there is a route deviated from an allocation condition when the communication route is allocated to the virtual line (Step S11).

When determining there is a communication route deviated from the allocation condition, the monitoring unit 21 designates the route allocation unit 13 to change allocation of a communication route of the virtual line (Step S12).

Thereafter, similarly to the first example embodiment, operations from Step S1 to Step S7 are performed, and allocation of a communication route of the virtual line is changed.

In this configuration, in addition to the advantageous effect according to the first example embodiment, it is possible to allocate a communication route according to a priority of a virtual line, while a frequency and a tendency of occurrence of a communication failure are considered, even when a communication failure situation changes from a time when a communication route is allocated to a virtual line.

In the first and second example embodiments, a control device may include an unillustrated operation unit, and an allocation condition of a communication route allocated in the past, for example, a priority, a band, and the like may be changeable by a user's operation to the operation unit. In this case, the monitoring unit 21 may determine that there is a communication route deviated from an allocation condition by Steps S10 and S11, and designate the route allocation unit 13 to change allocation of a communication route. Alternatively, the monitoring unit 21 may not perform Steps S10 and S11; and the monitoring unit 21 may determine that there is a communication route deviated from an allocation condition, based on an operation of changing an allocation condition by a user, and may designate the route allocation unit 13 to change allocation of a communication route.

While the invention has been particularly shown and described with reference to example embodiments thereof, the invention is not limited to these embodiments. It will be understood by those of ordinary skill in the art that various changes in form and details may be made therein without departing from the spirt and scope of the present invention as defined by the claims. For example, a method for achieving a virtual line may employ a virtual local area network (VLAN).

The whole or part of the example embodiments disclosed above can be described as the following supplementary notes. In the following, an overview of a control device and the like according to the present invention is described. However, the present invention is not limited to the following configuration.

### (Supplementary Note 1)

A control device for controlling a communication device constituting a communication network including a wireless communication section, the control device including:

a storage means for storing a communication failure history in the wireless communication section;

a determination means for determining stability of the wireless communication section, based on the communication failure history; and

a route allocation means for allocating a communication route, based on the stability.

### (Supplementary Note 2)

The control device according to Supplementary Note 1, wherein information on a communication failure occurring in a past predetermined period is recorded in the communication failure history in association with a communication route present in the wireless communication section.

### (Supplementary Note 3)

The control device according to Supplementary Note 2, wherein a band is recorded in the communication failure history in association with a communication route present in the wireless communication section.

### (Supplementary Note 4)

The control device according to any one of Supplementary Notes 1 to 3, wherein the route allocation means allocates, to a virtual line, the communication route having the stability according to a priority of the virtual line.

### (Supplementary Note 5)

The control device according to Supplementary Note 4, wherein, when a communication route having the stability according to the priority is allocated to another virtual line, the route allocation means determines whether allocation of a communication route of the another virtual line is changeable, and when changing is possible, changes allocation of a communication route of the another virtual line.

### (Supplementary Note 6)

The control device according to Supplementary Note 4 or 5, further including a monitoring means for monitoring whether there is the virtual line deviated from an allocation condition when a communication route is allocated.

### (Supplementary Note 7)

The control device according to Supplementary Note 6, wherein

the communication failure history is periodically updated, and

the monitoring means periodically acquires a band of the communication route from the communication failure history, acquires the stability calculated from the determination means, and determines whether there is the virtual line in which the communication route is deviated from the allocation condition, based on the acquired band and stability.

### (Supplementary Note 8)

A communication system including:

the control device according to any one of Supplementary Notes 1 to 7; and

the communication device.

### (Supplementary Note 9)

A control method of a control device for controlling a communication device constituting a communication network including a wireless communication section, the control method including:

storing a communication failure history in the wireless communication section;

determining stability of the wireless communication section, based on the communication failure history; and

allocating a communication route, based on the stability.

### (Supplementary Note 10)

The control method according to Supplementary Note 9, further including recording, in the communication failure history, information on a communication failure occurring in a past predetermined period in association with a communication route present in the wireless communication section.

### (Supplementary Note 11)

The control method according to Supplementary Note 10, further including recording, in the communication failure history, the information on the communication failure and a band in association with a communication route present in the wireless communication section.

### (Supplementary Note 12)

The control method according to any one of Supplementary Notes 9 to 11, wherein, when the communication route is allocated based on the stability, the communication route having the stability according to a priority of a virtual line is allocated to the virtual line.

### (Supplementary Note 13)

The control method according to Supplementary Note 12, wherein, when the communication route is allocated based on the stability in case where a communication route having the stability according to the priority is already allocated to another virtual line, it is determined whether allocation of a communication route of the another virtual line is changeable, and allocation of a communication route of the another virtual line is changed if it is possible to change the allocation.

### (Supplementary Note 14)

A control method of a communication system including a communication device constituting a communication network including a wireless communication section, and a control device for controlling the communication device, the control method including:

storing a communication failure history in a wireless communication section of a communication network;

determining stability of the wireless communication section, based on the communication failure history; and

allocating a communication route, based on the stability.

This application is based upon and claims the benefit of priority from Japanese patent application No. 2017-251493, filed on Dec. 27, 2017, the disclosure of which is incorporated herein in its entirety by reference.

### REFERENCE SIGNS LIST

1, 5 Communication system
2A, 2B, 2C Communication device
3 Base station
4 Core network
10, 20 Control device
11 Storage unit
12 Determination unit
13 Route allocation unit
21 Monitoring unit

1. A control device for controlling a communication device constituting a communication network including a wireless communication section, the control device comprising:
a storage unit that stores a communication failure history in the wireless communication section;
a determination unit that determines stability of the wireless communication section, based on the communication failure history; and
a route allocation unit that allocates a communication route, based on the stability.

2. The control device according to claim 1, wherein
information on a communication failure occurring in a past predetermined period is recorded in the communication failure history in association with a communication route present in the wireless communication section.

3. The control device according to claim 2, wherein
a band is recorded in the communication failure history in association with a communication route present in the wireless communication section.

4. The control device according to claim 1, wherein
the route allocation unit allocates, to a virtual line, the communication route having the stability according to a priority of the virtual line.

5. The control device according to claim 4, wherein,
when a communication route having the stability according to the priority is allocated to another virtual line, the route allocation unit determines whether allocation of a communication route of the another virtual line is changeable, and when changing is possible, changes allocation of a communication route of the another virtual line.

6. The control device according to claim 4, further comprising
a monitoring unit that monitors whether there is the virtual line deviated from an allocation condition when a communication route is allocated.

7. The control device according to claim 6, wherein
the communication failure history is periodically updated, and
the monitoring unit periodically acquires a band of the communication route from the communication failure history, acquires the stability calculated from the determination unit, and determines whether there is the virtual line in which the communication route is deviated from the allocation condition, based on the acquired band and stability.

8. A communication system comprising:
the control device according to claim 1; and
the communication device.

9. A control method of a control device for controlling a communication device constituting a communication network including a wireless communication section, the control method comprising:
storing a communication failure history in the wireless communication section;
determining stability of the wireless communication section, based on the communication failure history; and
allocating a communication route, based on the stability.

10. The control method according to claim 9, further comprising
recording, in the communication failure history, information on a communication failure occurring in a past predetermined period in association with a communication route present in the wireless communication section.

11. The control method according to claim 10, further comprising
recording, in the communication failure history, the information on the communication failure and a band in association with a communication route present in the wireless communication section.

12. The control method according to claim 9, wherein,
when the communication route is allocated based on the stability, the communication route having the stability according to a priority of a virtual line is allocated to the virtual line.

13. The control method according to claim 12, wherein,
when the communication route is allocated based on the stability in case where a communication route having the stability according to the priority is already allocated to another virtual line, it is determined whether allocation of a communication route of the another virtual line is changeable, and allocation of a communication route of the another virtual line is changed if it is possible to change the allocation.

14. A control method of a communication system including a communication device constituting a communication network including a wireless communication section, and a control device for controlling the communication device, the control method comprising:
storing a communication failure history in a wireless communication section of a communication network;
determining stability of the wireless communication section, based on the communication failure history; and
allocating a communication route, based on the stability.

15. The control method according to claim 14, further comprising
recording, in the communication failure history, information on a communication failure occurring in a past predetermined period in association with a communication route present in the wireless communication section of the communication network.

16. The control method according to claim 15, further comprising
recording, in the communication failure history, the information on the communication failure and a band in association with a communication route present in the wireless communication section of the communication network.

17. The control method according to claim 14, further comprising,
when allocating a communication route, based on the stability, allocating, to a virtual line, the communication route having the stability according to a priority of the virtual line.

18. The control method according to claim 17, further comprising,
when allocating a communication route, based on the stability, in a case where a communication route having the stability according to the priority is allocated to another virtual line, determining whether allocation of a communication route of the another virtual line is changeable, and when changing is possible, changing allocation of a communication route of the another virtual line.
